(19) United States
(12) Patent Application Publication
(10) Pub. No.: US 2018/0167577 A1
(43) Pub. Date: Jun. 14, 2018

(54) DISPLAY APPARATUS PRESENTING STATUS OF EXTERNAL ELECTRONIC APPARATUS AND CONTROLLING METHOD THEREOF

(71) Applicant: SAMSUNG ELECTRONICS CO., LTD., Suwon-si (KR)

(72) Inventors: Chun RYU, Gwangju (KR); Sung Hyuk Kwon, Suwon-si (KR); So Young Park, Daejeon (KR); Jae Julien, Seoul (KR)

(73) Assignee: SAMSUNG ELECTRONICS CO., LTD., Suwon-si (KR)

(21) Appl. No.: 15/838,633

(22) Filed: Dec. 12, 2017

(30) Foreign Application Priority Data
Dec. 12, 2016 (KR) 10-2016-0168503

(51) Int. Cl. H04N 5/63; H04N 5/44; H04N 5/445

(52) U.S. Cl. CPC H04N 5/63; H04N 2005/44517; H04N 5/44513; H04N 5/4403

(57) ABSTRACT

A display apparatus is provided. The display apparatus includes: a wired interface; a display; and a processor configured to determine a connection status of the external electronic apparatus with respect to the wired interface, to determine a power status of the external electronic apparatus determined to be connected to the wired interface, and to control to present, in a user interface (UI) on the display, the determined power status of the external electronic apparatus.

### CROSS-REFERENCE TO RELATED APPLICATION

This application claims priority from Korean Patent Application No. 10-2016-0168503, filed on Dec. 12, 2016 in the Korean Intellectual Property Office, the entire disclosure of which is hereby incorporated by reference.

### TECHNICAL FIELD

Apparatuses and methods consistent with one or more exemplary embodiments relate to a display apparatus presenting a status of an external electronic apparatus in a user interface (UI) and a controlling method thereof.

### BACKGROUND

A display apparatus is an apparatus that displays an image signal provided from the outside (i.e., an external source). Related art display apparatuses not only provide functions or information to a user unilaterally, but also provide various functions or information in response to user requests. For example, a related art television (TV) may provide a user interaction function as well as a broadcasting receiving function.

Furthermore, with the development of communication technologies, it may be possible to provide various services through interworking between electronic apparatuses. In particular, a display apparatus may be connected to external electronic apparatuses, such as a set-top box, a game console, a smartphone, and the like, to provide a variety of content to the user.

In the case where a plurality of external electronic apparatuses are connected to a display apparatus in different manners, ways to present connection statuses of the plurality of external electronic apparatuses and selection manners for connection are different from each other, thereby making it difficult for a user to manage the connection statuses of the plurality of external electronic apparatuses.

Also, it may be difficult to determine or identify the connection statuses and power statuses of the plurality of external electronic apparatuses connected to the display apparatus. In the case where an external electronic apparatus is powered off or is disconnected from the display apparatus, even though it is possible to identify the connection statuses and the power statuses, it may be difficult for the user to control the external electronic apparatus through the display apparatus.

### SUMMARY

Aspects of one or more exemplary embodiments provide a display apparatus capable of integrally managing connection statuses and power statuses of a plurality of external electronic apparatuses connected to the display apparatus and a controlling method thereof.

According to an aspect of an exemplary embodiment, there is provided a display apparatus including: a wired interface; a display; and a processor configured to: determine a connection status of an external electronic apparatus with respect to the wired interface, determine a power status of the external electronic apparatus determined to be connected to the wired interface, and control to present, in a user interface (UI) on the display, the determined power status of the external electronic apparatus.

The processor may be configured to: verify at least one of a voltage pulled when the external electronic apparatus is connected, extended display identification data (EDID) of the external electronic apparatus, and a content signal to verify the connection status of the external electronic apparatus.

The processor may be configured to: receive a user input with respect to the UI from a user; select the external electronic apparatus corresponding to the user input; and connect to the selected external electronic apparatus via the wired interface.

The processor may be configured to: if power of the selected external electronic apparatus is turned off, control to turn on the power of the selected external electronic apparatus and to connect the turned-on external electronic apparatus via the wired interface.

The processor may be configured to: set the selected external electronic apparatus, which is connected via the wired interface, as a source apparatus, an image from which is displayed on the display.

The processor may be configured to: if power of a specified external electronic apparatus is turned on while power of the display apparatus is turned on, set the specified external electronic apparatus as a source apparatus, an image from which is displayed on the display; and if the power of the specified external electronic apparatus is turned off while the power of the display apparatus is turned on, control to turn on the power of the specified external electronic device and set the specified external electronic apparatus as the source apparatus, the image from which is displayed on the display.

The specified external electronic apparatus may be an external electronic apparatus that is last connected via the wired interface, an external electronic apparatus that is most connected to the wired interface, or an external electronic apparatus, power of which is being turned on.

The processor may be configured to: if power of the external electronic apparatus is turned on, control to connect the external electronic apparatus via the wired interface and set the external electronic apparatus as a source apparatus, an image of which is displayed on the display.

The processor may be configured to: if the power of the external electronic apparatus is turned on when power of the display apparatus is turned off, control to turn on the power of the display apparatus.

The processor may be configured to: if power of the external electronic apparatus is turned on, determine whether the external electronic apparatus transmits an image; and based on determining that the external electronic apparatus does not transmit the image, control to not change a source apparatus, an image of which is displayed on the display, to the external electronic apparatus.

The display apparatus may further include: a wireless interface, wherein the processor may be configured to: determine a connection status of an external electronic apparatus connected to the wireless interface, and control to present the determined connection status of the external electronic apparatus connected to the wireless interface in the UI.

The processor may be configured to: based on the external electronic apparatus being paired with the wireless interface or the display apparatus, control to connect to the external electronic apparatus via the wireless interface.

The processor may be configured to: if the external electronic apparatus is paired with the wireless interface while power of the external electronic apparatus connected to the wireless interface is turned on, control to connect to the external electronic apparatus via the wireless interface.

The processor may be configured to: set the external electronic apparatus connected to the wireless interface as an output apparatus to output an audio signal from the display apparatus.

According to an aspect of another exemplary embodiment, there is provided a controlling method of a display apparatus, the method including: determining a connection status of an external electronic apparatus with respect to a wired interface; determining a power status of the external electronic apparatus determined to be connected to the wired interface; and presenting a user interface (UI) indicating the determined power status of the external electronic apparatus.

The determining of the connection status of the external electronic apparatus may include: verifying at least one of a voltage pulled when the external electronic apparatus is connected, extended display identification data (EDID) of the external electronic apparatus, and a content signal to verify the connection status of the external electronic apparatus.

The method may further include: receiving a user input with respect to the UI from a user; selecting the external electronic apparatus corresponding to the user input; and connecting to the selected external electronic apparatus via the wired interface.

The connecting to the selected external electronic apparatus may include: controlling to turn on power of the selected external electronic apparatus if the power of the selected external electronic apparatus is turned off; and connecting to the turned-on external electronic apparatus via the wired interface.

The method further includes: setting the selected external electronic apparatus connected via the wired interface as a source apparatus, an image from which is displayed on the display.

According to an aspect of another exemplary embodiment, there is provided a non-transitory computer-readable storage medium storing a program executable by a computer for performing a method, the method including: determining a connection status of an external electronic apparatus with respect to a wired interface; determining a power status of the external electronic apparatus; and presenting, on a display, a user interface (UI) indicating the determined power status of the external electronic apparatus.

Other aspects, advantages, and salient features will become apparent to those skilled in the art from the following detailed description, which, taken in conjunction with the attached drawings, discloses various exemplary embodiments.

### BRIEF DESCRIPTION OF THE DRAWINGS

The above and/or other aspects, features, and advantages of certain exemplary embodiments of the present disclosure will be more apparent from the following description taken in conjunction with the accompanying drawings, in which:

FIG. 1 is a view illustrating a display system according to an exemplary embodiment;

FIG. 2 is a block diagram illustrating a configuration of a display apparatus according to an exemplary embodiment;

FIG. 3 is a view presenting a user interface (UI) of a display apparatus according to an exemplary embodiment;

FIG. 4 is a flowchart illustrating a case where a display apparatus according to an exemplary embodiment receives a user input;

FIGS. 5A to 5C are views illustrating a UI displayed on a display in the case where a display apparatus according to an exemplary embodiment receives a user input;

FIG. 6 is a flowchart illustrating a case where power of a display apparatus according to an exemplary embodiment is turned on;

FIG. 7 is a flowchart illustrating an operation of a display apparatus according to an exemplary embodiment when power of an external electronic apparatus is turned on;

FIG. 8 is a view illustrating an image displayed on a display after an external electronic apparatus is connected to a display apparatus according to an exemplary embodiment;

FIG. 9 is a flowchart illustrating an operation of a display apparatus according to an exemplary embodiment, when power of an external electronic apparatus is turned on;

FIG. 10 is a flowchart illustrating a case where a display apparatus according to an exemplary embodiment is paired with an external electronic apparatus;

FIGS. 11A and 11B are views illustrating a UI displayed on a display in a case where an external electronic apparatus is paired with a display apparatus according to an exemplary embodiment;

FIG. 12 is a flowchart illustrating a case where a display apparatus according to an exemplary embodiment is connected to a paired external electronic apparatus;

FIGS. 13A and 13B are views illustrating a UI displayed on a display in a case where a paired external electronic apparatus is connected to a display apparatus according to an exemplary embodiment; and

FIG. 14 is a flowchart illustrating a controlling method of a display apparatus according to an exemplary embodiment.

### DETAILED DESCRIPTION

Below, various exemplary embodiments will be described with reference to accompanying drawings. However, those of ordinary skill in the art will recognize that modifications, combinations, equivalents, and/or alternatives on the various exemplary embodiments described herein can be variously made without departing from the scope and spirit of the present inventive concept(s). With regard to description of drawings, similar elements may be marked by similar reference numerals.

As used herein, the term “and/or” includes any and all combinations of one or more of the associated listed items. Expressions such as “at least one of,” when preceding a list of elements, modify the entire list of elements and do not modify the individual elements of the list.

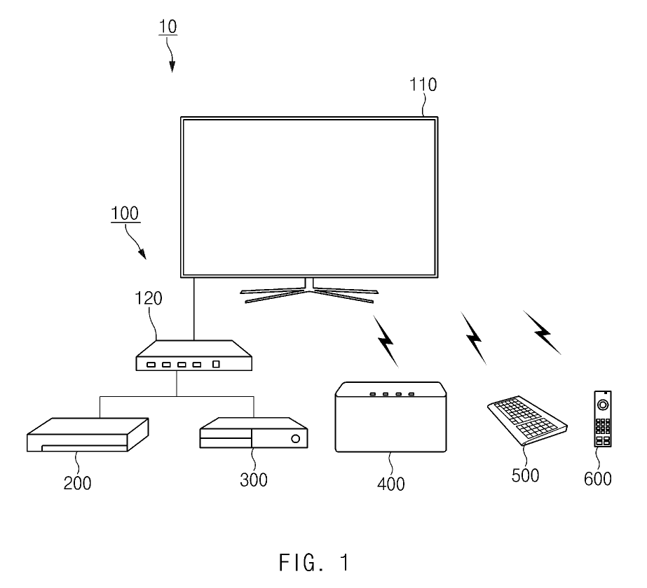

FIG. 1 is a view illustrating a display system 10 according to an exemplary embodiment.

Referring to FIG. 1, a display system 10 may include a display apparatus 100, a first external electronic apparatus 200, a second external electronic apparatus 300, a third external electronic apparatus 400, a fourth external electronic apparatus 500, and a remote control apparatus 600.

The display apparatus 100 may include an image display apparatus 110 and a connection apparatus 120. The display apparatus 100 may play content including an image (e.g., a video image) and an audio signal. For example, the display apparatus 100 may be implemented by any of various apparatuses or components that are able to display an image of content and output an audio signal of the content. Examples of the display apparatus 100 include a television (TV), a desktop personal computer (PC), a notebook PC, a smartphone, a tablet PC, a portable media player, a monitor, an electronic frame, a workstation, and the like.

The image display apparatus 110 may play or output content. For example, the image display apparatus 110 may display an image of content stored in a memory on a display panel and may output an audio signal of the content through a speaker. By way of another example, the image display apparatus 110 may display an image of content received from a source apparatus on the display panel and may output an audio signal of the content through the speaker.

The connection apparatus 120 may be connected to the image display apparatus 110. The connection apparatus 120 may be physically separated from the image display apparatus 110 and may be wiredly connected to the image display apparatus 110. According to an exemplary embodiment, the connection apparatus 120 may be wiredly connected to a plurality of external electronic apparatuses 200, 300. According to another exemplary embodiment, the connection apparatus 120 may be wirelessly connected to the image display apparatus 110 and/or may be wirelessly connected to the plurality of external electronic apparatuses 200, 300.

The image display apparatus 110 may receive content from an external electronic apparatus 200, 300 through the connection apparatus 120 and may play (e.g., reproduce and/or output) the received content. Further, the image display apparatus 110 may transmit an audio signal of the played content to an external electronic apparatus connected through the connection apparatus 120. The external electronic apparatus may be, for example, a speaker apparatus that is wiredly connected to output an audio signal.

According to an exemplary embodiment, the image display apparatus 110 and the connection apparatus 120 may be implemented by one apparatus. In other words, the display apparatus 100 may be a single apparatus and may be connected to the plurality of external electronic apparatuses 200, 300, 400, 500.

The first external electronic apparatus 200 and the second external electronic apparatus 300 may be connected to the display apparatus 100. For example, the first external electronic apparatus 200 and the second external electronic apparatus 300 may be wiredly connected to the connection apparatus 120. Each of the first external electronic apparatus 200 and the second external electronic apparatus 300 may be a source apparatus that is able to transmit content to the display apparatus 100. For example, the first external electronic apparatus 200 and the second external electronic apparatus 300 may be implemented by any of various apparatuses that are able to receive and/or store content and transmit content to the display apparatus 100, such as a set-top box, a game console (e.g., Xbox™, PlayStation™, or the like), a smartphone, a desktop PC, a notebook PC, a tablet PC, an audio/video receiver, a media streaming device, a network streaming device, an optical recording medium playback device (such as a Blu-ray Disc player or a digital video disc (DVD) player), and the like.

The third external electronic apparatus 400 may be connected to the display apparatus 100. For example, the third external electronic apparatus 400 may be wirelessly connected to the image display apparatus 110. According to another exemplary embodiment, the third external electronic apparatus 400 may be wiredly connected to the image display apparatus 110. The third external electronic apparatus 400 may be an output apparatus that outputs an audio signal received from the display apparatus 100. For example, the third external electronic apparatus 400 may be implemented by any of various apparatuses that are able to output an audio signal, such as a wireless speaker apparatus, headphones, and the like.

The fourth external electronic apparatus 500 may be connected to the display apparatus 100. For example, the fourth external electronic apparatus 500 may be wirelessly connected to the image display apparatus 110. According to another exemplary embodiment, the fourth external electronic apparatus 500 may be wiredly connected to the image display apparatus 110. The fourth external electronic apparatus 500 may be a user input apparatus that is able to transmit a user input to the display apparatus 100. For example, the fourth external electronic apparatus 500 may be implemented by any of various apparatuses that are able to transmit a user input, such as a wireless keyboard, a wireless mouse, a motion sensor, a gesture sensor, an image capturing device, and the like.

The remote control apparatus 600 may be connected to the display apparatus 100. For example, the remote control apparatus 600 may be wirelessly connected to the image display apparatus 110. The remote control apparatus 600 may be a user input apparatus that is able to transmit a user input to the display apparatus 100 and is able to receive a command from the display apparatus 100 and transmit the command to another external electronic apparatus.

The display apparatus 100 may be connected to the plurality of external electronic apparatuses in different manners. The display apparatus 100 may receive and play content from a plurality of source apparatuses. The display apparatus 100 may be connected to an output apparatus to output an audio signal of the played content. The display apparatus 100 may be connected to a plurality of user input apparatuses to receive a user input. As such, the display apparatus 100 may manage a plurality of external electronic apparatuses. The display apparatus 100 according to an exemplary embodiment may integrally manage the plurality of external electronic apparatuses by verifying connection statuses of the plurality of external electronic apparatuses, monitoring power statuses of the plurality of external electronic apparatuses that are connected, and presenting statuses of the plurality of external electronic apparatuses in a user interface (UI).

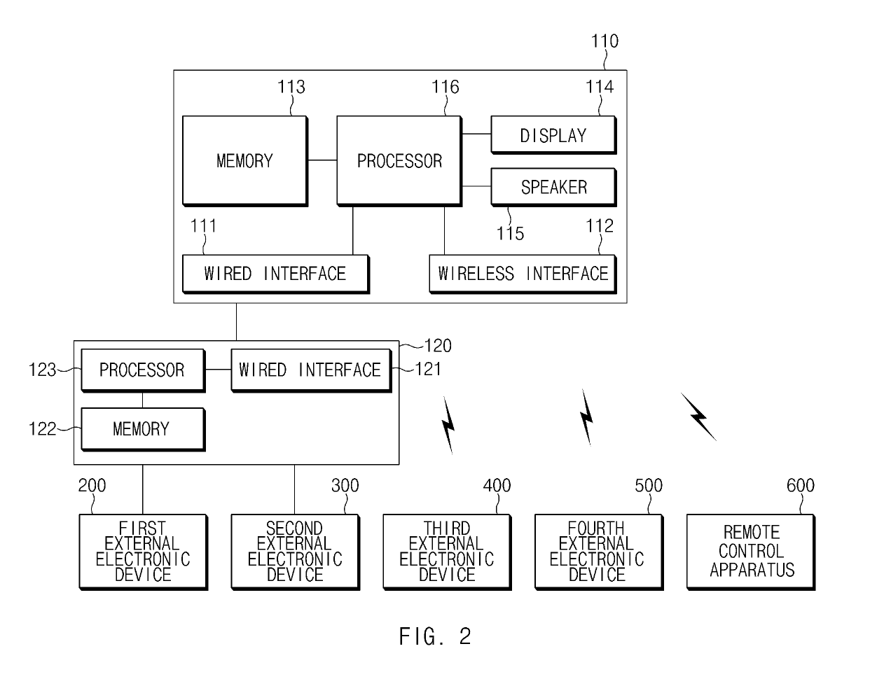

FIG. 2 is a block diagram illustrating a configuration of a display apparatus 100 according to an exemplary embodiment.

Referring to FIG. 2, the display apparatus 100 may include an image display apparatus 110 and a connection apparatus 120.

The image display apparatus 110 may include a wired interface 111, a wireless interface 112, a memory 113, a display 114, a speaker 115, and a processor 116.

The wired interface 111 may perform wired communication with the connection apparatus 120. For example, the wired interface 111 may be connected to a plurality of external electronic apparatuses 200, 300 through one or more wired connections with the connection apparatus 120. The wired interface 111 may include, for example, at least one of a serializer/deserializer (SerDes) interface, a high definition multimedia interface (HDMI), a digital video/visual interactive (DVI) interface, a video graphics array (VGA) interface, a component interface, etc. The wired interface 111 may receive content from an external electronic apparatus 200, 300 through the connection apparatus 120. Additionally, the wired interface 111 may transmit an audio signal of content played in the image display apparatus 110 to an external electronic apparatus (e.g., a wired speaker apparatus) through the connection apparatus 120.

The wireless interface 112 may perform wireless communication with an external electronic apparatus 400, 500, 600. For example, the wireless interface 112 may be wirelessly connected to the external electronic apparatus 400, 500, 600. The wireless interface 112 may include, for example, at least one of a Bluetooth interface, a near field communication (NFC) interface, and a wireless-fidelity (Wi-Fi) interface. The wireless interface 112 may transmit an audio signal to an external electronic apparatus. The external electronic apparatus may output, for example, the transmitted audio signal. Additionally, the wireless interface 112 may receive content from an external electronic apparatus (e.g., a wireless source apparatus).

The memory 113 may store content including an image and an audio signal. The image of the content stored in the memory 113 may be displayed on the display 114, and the audio signal of the stored content may be output through the speaker 115. According to an exemplary embodiment, the memory 113 may store a user interface (UI) presenting power statuses and connection statuses of a plurality of external electronic apparatuses. For example, the memory 113 may store a UI including a power status and a connection status implemented with at least one of a text, an image, and an icon.

The display 114 may display an image of content. For example, the display 114 may display the image of the content stored in the memory 113. By way of another example, the display 114 may receive content from an external electronic apparatus and may display an image included in the content. The display 114 may display a UI. The display 114 may display the image of the content and the UI at the same time.

The speaker 115 may output an audio signal of content. For example, the speaker 115 may output an audio signal of content stored in the memory 113. By way of another example, the speaker 115 may receive content from an external electronic apparatus and may output an audio signal included in the content. According to an exemplary embodiment, in the case where an external speaker apparatus is connected through the wired interface 111 and/or the wireless interface 112, the speaker 114 may not output the audio signal of the content. The audio signal of the content may be transmitted to the external speaker apparatus connected through the wired interface 111 and/or the wireless interface 112 so as to be output to the outside.

The processor 116 may control overall operations of the image display apparatus 110. For example, the processor 116 may control the wireless interface 111 so as to be connected to the connection apparatus 120. The processor 116 may control the wireless interface 112 so as to be connected to an external electronic apparatus. The processor 116 may play content stored in the memory 113 or content received from an external electronic apparatus.

The processor 116 may be connected to the connection apparatus 120 through the wired interface 111 and may receive content from the first external electronic apparatus 200 or the second external electronic apparatus 300 connected to the connection apparatus 120. The connection apparatus 120 may be connected to the image display apparatus 110 by using, for example, a SerDes connection manner. Furthermore, the processor 116 may be connected to an external electronic apparatus (e.g., a wireless source apparatus) through the wireless interface 112 so as to receive content. The processor 116 may display an image of the received content on the display 114 and may output an audio signal of the received content through the speaker 115.

The processor 116 may change (or control to change) a source apparatus, from which content will be played (e.g., an active source apparatus), from one source apparatus to another source apparatus. For example, the processor 116 may change an active source apparatus from the first external electronic apparatus 200 to the second external electronic apparatus 300. If, for example, a communication manner (e.g., an HDMI manner) of the first external electronic apparatus 200 is different from a communication manner (e.g., a DVI manner) of the second external electronic apparatus 300, the processor 116 may change or switch a communication manner. As such, the processor 116 may stop playing content of the first external electronic apparatus 200 and may play content of the second external electronic apparatus 300.

The processor 116 may transmit (or control to transmit) an audio signal to an external electronic apparatus (e.g., a wired speaker apparatus) connected to the connection apparatus 120 through the wired interface 111. Furthermore, the processor 116 may be connected to the third external electronic apparatus 400 through the wireless interface 112 so as to transmit an audio signal thereto wirelessly. The processor 116 may transmit an audio signal of played content to the third external electronic apparatus 400 so as to be output to the outside. For example, the external electronic apparatus may be connected to the image display apparatus 110 by using a Bluetooth manner.

The processor 116 may change (or control to change) an output apparatus, which will output content (e.g., an active output apparatus), from one output apparatus to another output apparatus. For example, the processor 116 may change an active output apparatus, which will output an audio signal of content, from a wired speaker apparatus to the third external electronic apparatus 400. If, for example, a communication manner (e.g., a HDMI manner) of the wired speaker apparatus is different from a communication manner (e.g., a Bluetooth manner) of the third external electronic apparatus 400, the processor 116 may change or switch a communication manner. As such, the processor 116 may allow or control the wired speaker apparatus to stop outputting an audio signal and may allow or control the third external electronic apparatus 400 to output an audio signal.

Additionally, the processor 116 may be connected to the fourth external electronic apparatus 500 and the remote control apparatus 600 through the wireless interface 112 so as to receive a user input. The fourth external electronic apparatus 500 and the remote control apparatus 600 may be connected to the image display apparatus 110 by using at least one of, for example, a Bluetooth manner and a Wi-Fi manner. According to an exemplary embodiment, the processor 116 may receive the user input and may connect (or control to connect) a source apparatus, an output apparatus, and/or a user input apparatus corresponding to the user input.

Additionally, the processor 116 may be connected to the remote control apparatus 600 through the wireless interface 112 so as to transmit (or control to transmit) a command. For example, the processor 116 may transmit a command to turn on power of an external electronic apparatus to the remote control apparatus 600. The remote control apparatus 600 may receive the command and may transmit the command to an external electronic apparatus corresponding to the command. The external electronic apparatus 600 may transmit the command to the external electronic apparatus corresponding to the command, for example, by using infrared (IR) communication.

The processor 116 may receive user inputs from a plurality of user input apparatuses. For example, the processor 116 may simultaneously connect the fourth external electronic apparatus 500 and the remote control apparatus 600 to the wireless interface 112 to receive user inputs from the fourth external electronic apparatus 500 and the remote control apparatus 600.

According to an exemplary embodiment, the processor 116 may verify a connection status and/or a power status of an external electronic apparatus. For example, the processor 116 may receive information about a connection status and/or a power status of the external electronic apparatus from the connection apparatus 120 to verify the connection status and/or the power status of the external electronic apparatus. According to an exemplary embodiment, the processor 116 may display (or control to display) a UI presenting at least one of a connection status and a power status of an external electronic apparatus on the display 114.

The processor 116 may select (or change) an external electronic apparatus (e.g., a source apparatus) that will play content. For example, if receiving a user input, the processor 116 may select an external electronic apparatus corresponding to the user input as an external electronic apparatus that will play content. By way of another example, when power is turned on, the processor 116 may select a specified external electronic apparatus (e.g., a lastly connected external electronic apparatus, an electronic apparatus that is the connected to most, a default or prioritized electronic apparatus, or the like) as an external electronic apparatus that will play content. By way of another example, if an external electronic apparatus is turned on, the processor 116 may verify a change in a power status of the external electronic apparatus and may select the turned-on external electronic apparatus as an external electronic apparatus that will play content.

The processor 116 may receive content from the selected source apparatus and may play (or control to play) the received content. For example, the processor 116 may display an image of the content on the display 114 and may output an audio signal of the content through the speaker 115.

As such, the processor 116 may change a source apparatus, which will play content, from an external electronic apparatus that previously plays content to the selected external electronic apparatus.

According to an exemplary embodiment, in the case where power of an external electronic apparatus that will receive content is turned off, the processor 116 may turn on (or control to turn on) the power of the external electronic apparatus. For example, in the case where power of an external electronic apparatus corresponding to a received user input is turned off, the processor 116 may turn on the power of the external electronic apparatus corresponding to the user input. By way of another example, in the case where power of a specified external electronic apparatus is turned off when power is turned on, the processor 116 may turn on the power of the specified external electronic apparatus. The external electronic apparatus may be, for example, a wiredly connected external electronic apparatus. According to an exemplary embodiment, the processor 116 may directly transmit (or control to directly transmit) a command (e.g., a command to turn on power) to the external electronic apparatus through the wired interface 111 or may transmit the command to the external electronic apparatus through the remote control apparatus 600, such that the power of the external electronic apparatus is turned on.

The connection apparatus 120 may include a wired interface 121, a memory 122, and a processor 123.

The wired interface 121 may perform wired communication with the image display apparatus 110 and a plurality of external electronic apparatuses. For example, the wired interface 121 may include at least one of a SerDes interface, an HDMI interface, a DVI interface, a VGA interface, a component interface, etc. The wired interface 121 may receive content from a plurality of external electronic apparatuses connected to the wired interface 121 and may transmit the received content to the image display apparatus 110. Furthermore, the wired interface 121 may receive an audio signal of content being played in the image display apparatus 110 and may transmit the received audio signal to an external electronic apparatus.

The memory 122 may store status information of an external electronic apparatus connected to the wired interface 121. For example, the memory 122 may store status information of the first external electronic apparatus 200 and the second external electronic apparatus 300.

The processor 123 may control overall operations of the connection apparatus 120. For example, the processor 123 may control the wired interface 121 so as to be connected to the image display apparatus 110 and a plurality of external electronic apparatuses. The processor 123 may control the memory 122 to store a status of an external electronic apparatus in the memory 122.

According to an exemplary embodiment, the processor 123 may receive content from the first external electronic apparatus 200 and the second external electronic apparatus 300 connected to the wired interface 121 and may transmit the received content to the image display apparatus 110. The external electronic apparatus may be connected to the image display apparatus 110 by using, for example, a HDMI communication manner.

The processor 123 may receive an audio signal of content being played in the image display apparatus 110 connected to the wired interface 121 and may transmit the audio signal to an external electronic apparatus (e.g., a wired speaker apparatus). The external electronic apparatus may be connected to the connection apparatus 120 by using, for example, a HDMI communication manner.

The processor 123 may verify a connection status of an external electronic apparatus connected to the wired interface 121 and may verify (or monitor) a power status of the external electronic apparatus that is connected.

For example, the processor 123 may monitor a pulled-up voltage, extended display identification data (EDID) of an external electronic apparatus, and a content signal to verify a connection status of an external electronic apparatus. The processor 123 may measure a specified voltage (e.g., 5 V) pulled up when the first external electronic apparatus 200 and the second external electronic apparatus 300 are connected to ports of the wired interface 121. The processor 123 may verify the EDID of the first external electronic apparatus 200 and the second external electronic apparatus 300. The EDID may include unique information of each external electronic apparatus as data for authentication between apparatuses. The processor 123 may verify the content signal (e.g., a transition minimized display signaling (TMDS) signal) received from the first external electronic apparatus 200 and the second external electronic apparatus 300.

In the case where the specified voltage is measured and the content signal is received, the processor 123 may determine that an external electronic apparatus is connected to the wired interface 121 and power of the external electronic apparatus is turned on. In the case where the specified voltage is measured and the content signal is not received or in the case where the specified voltage is not measured and the EDID is verified, the processor 123 may determine that an external electronic apparatus is connected to the wired interface 121 and power of the external electronic apparatus is turned off. In the case where the specified voltage is not measured and the EDID is not verified (e.g., in the case where the EDID is not detected or in the case where another EDID is detected), the processor 123 may determine that an external electronic apparatus is not connected to the wired interface 121.

As such, the processor 123 may verify a connection status and a power status of an external electronic apparatus. In other words, the processor 123 may distinguish a power-on/off state of an external electronic apparatus and a disconnection state (a state where connection with the wired interface 121 is released) of the external electronic apparatus from a power-off state.

According to an exemplary embodiment, the processor 123 may store (or control to store) a connection status and/or a power status of an external electronic apparatus in a memory. For example, the processor 123 may verify connection statuses and/or power statuses of the first external electronic apparatus 200 and the second external electronic apparatus 300 at a specified period and may store the periodically verified connection and/or power statuses in the memory 122. According to an exemplary embodiment, the image display apparatus 110 may receive information about a connection status and/or a power status of an external electronic apparatus stored in the memory 122 to verify a status of the external electronic apparatus.

The display apparatus 100 may verify a connection status and/or a power status of an external electronic apparatus wiredly connected to the display apparatus 100 and may verify a connection status of an external electronic apparatus wirelessly connected thereto. The display apparatus 100 may present the verified information in a UI. A user may integrally manage a plurality of external electronic apparatuses connectable to the display apparatus 100 through the UI. Also, the display apparatus 100 may select an external electronic apparatus that will play (e.g., provide) content and may play content of the selected external electronic apparatus without delay to verify a connection status and a power status of the selected external electronic apparatus.

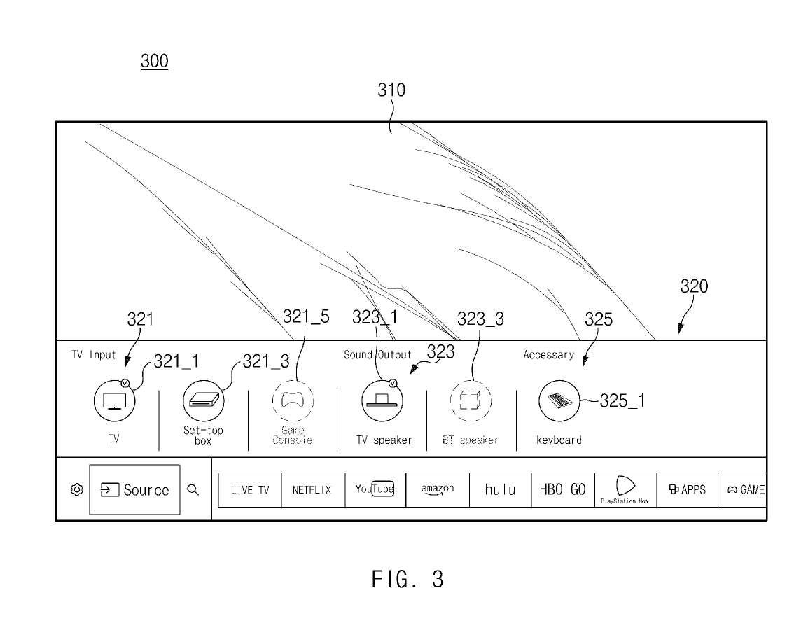

FIG. 3 is a view presenting a UI of a display apparatus 100 according to an exemplary embodiment in a display.

Referring to FIG. 3, a screen displayed on the display apparatus 100 may include a content image 310 and a UI 320.

The content image 310 may include an image of content being played by the display apparatus 100.

The UI 320 may be divided into a source apparatus menu 321, an output apparatus menu 323, and a user input apparatus menu 325 and may present at least one of connection statuses and power statuses of a plurality of external electronic apparatuses on the display apparatus 100.

The source apparatus menu 321 of the UI 320 may present a status of a source apparatus connected to the display apparatus 100. The source apparatus menu 321 of the UI 320 may include a first status mark (e.g., a check mark) of a source apparatus that is playing content, a second status mark (e.g., a bright mark) of a source apparatus that is connected to the display apparatus 100 and is powered on, and/or a third status mark (e.g., a dim mark) of a source apparatus that is connected to the display apparatus 100 and is powered off. The source apparatus menu 321 of the UI 320 may not present a source apparatus not connected to the display apparatus 100 in the UI 320, or may present the source apparatus that is not connected with a fourth status mark. The source apparatus menu 321 of the UI 320 may provide a status mark indicating that content is being played from one source apparatus.

For example, a display apparatus object 321_1 presenting a status (e.g., a check mark) of the display apparatus 100 may be marked to indicate a status that the content is played from the display apparatus 100. A first external electronic apparatus object 321_3 presenting a status of the first external electronic apparatus 200 may be marked to indicate a status (e.g., a bright mark) in which the first external electronic apparatus 200 is connected to the display apparatus 100 and power thereof is turned on. A second external electronic apparatus object 321_5 presenting a status of the second external electronic apparatus 300 may be marked to indicate a status in which the second external electronic apparatus 300 is connected to the display apparatus 100 and power thereof is turned off.

The output apparatus menu 323 of the UI 320 may present a status of an output apparatus capable of outputting an audio signal of content being played by the display apparatus 100 (or a status of an output apparatus connected to the display apparatus 100). The output apparatus menu 323 of the UI 320 may include a status mark (e.g., a check mark) of an output apparatus connected to the display apparatus 100 and a status mark (e.g., a dim mark) of an output apparatus being paired with the display apparatus 100.

For example, a display apparatus object 323_1 presenting a status of the display apparatus 100 may be marked to indicate a status (e.g., a check mark) that an audio signal of content is output by the display apparatus 100 (e.g., a speaker of the display apparatus). A third external electronic apparatus object 323_3 presenting a status of the third external electronic apparatus 400 may be marked to indicate a status (e.g., a dim mark) in which the third external electronic apparatus 400 is paired with the display apparatus 100.

The user input apparatus menu 325 of the UI 320 may present a status of a user input apparatus that is connected to the display apparatus 100 to transmit a user input. The user input apparatus menu 325 of the UI 320 may include a status mark (e.g., a bright mark) of an user input apparatus connected to the display apparatus 100.

For example, a fourth external electronic apparatus object 325_1 presenting a status of the fourth external electronic apparatus 500 may be marked to indicate a status (e.g., a bright mark) in which the fourth external electronic apparatus 500 is connected to the display apparatus 100.

As such, the display apparatus 100 may present at least one of connection statuses and power statuses of a plurality of external electronic apparatuses in the UI 320. A user may integrate and manage a plurality of external electronic apparatuses through the UI 320.

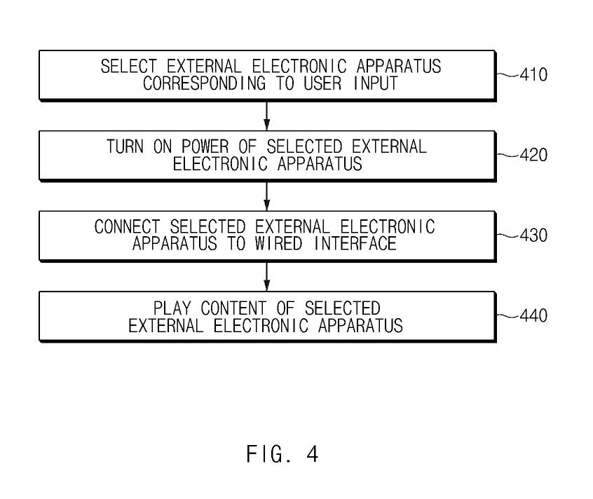

FIG. 4 is a flowchart illustrating a case where a display apparatus 100 according to an exemplary embodiment receives a user input.

Referring to FIG. 4, the display apparatus 100 may receive a user input and may select an external electronic apparatus (e.g., a source apparatus) corresponding to the user input in a UI presenting connection statuses and power statuses of a plurality of external electronic apparatuses. The display apparatus 100 may play (e.g., process and/or output for display) content received from the selected external electronic apparatus.

In operation 410, the display apparatus 100 may receive a user input and may select an external electronic apparatus corresponding to the user input in the UI. For example, a user may transmit a user input to select an external electronic apparatus through the remote control apparatus 600.

In operation 420, the display apparatus 100 may turn on power of the selected external electronic apparatus. For example, if the power of the selected external electronic apparatus is turned off, the display apparatus 100 may turn on (e.g., control to turn on) the power of the selected external electronic apparatus.

In operation 430, the display apparatus 100 may connect to the turned-on external electronic apparatus via a wired interface (e.g., make the turned-on external electronic apparatus the active source apparatus).

In operation 440, the display apparatus 100 may play content of an external electronic apparatus connected to the selected wired interface. For example, the display apparatus 100 may set the external electronic apparatus, which is selected and is connected to the wired interface, as a source apparatus, an image of which is displayed on the display and an audio signal of which is output through a speaker.

If the power of the selected external electronic apparatus is turned on, the display apparatus 100 may play content of the selected external electronic apparatus.

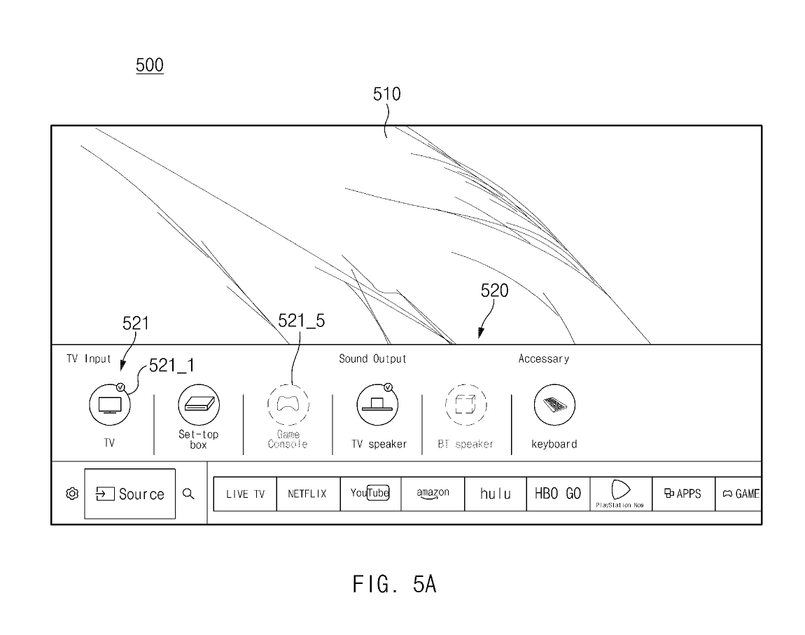

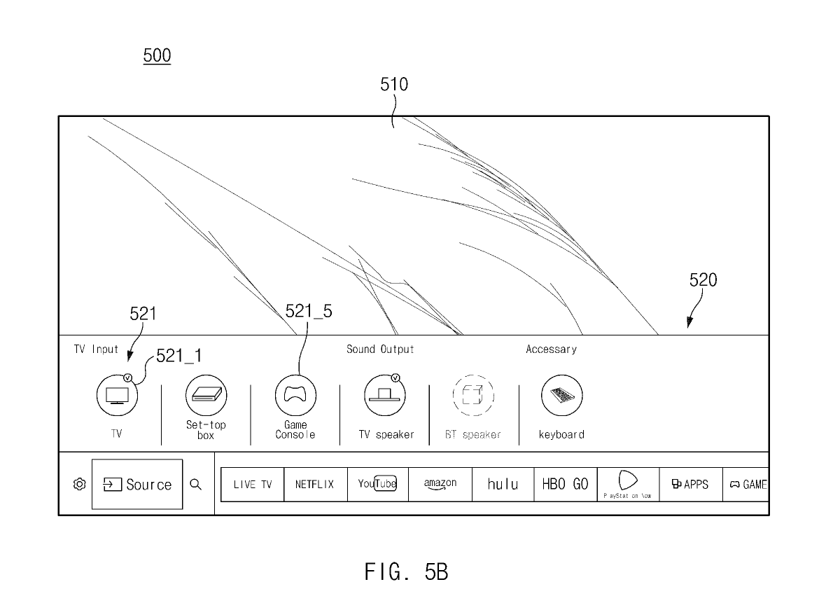

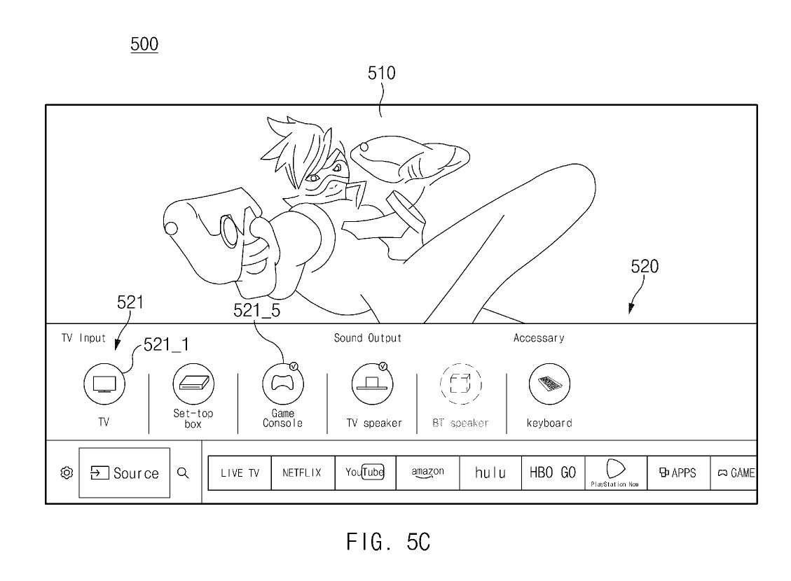

FIGS. 5A to 5C are views illustrating a UI displayed on a display in the case where a display apparatus 100 according to an exemplary embodiment receives a user input.

Referring to FIGS. 5A to 5C, a screen 500 displayed on a display of the display apparatus 100 may include a content image 510 and a UI 520.

Referring to FIG. 5A, the display apparatus 100 plays (e.g., processes, reproduces, and/or outputs for display) content stored in the display apparatus 100, and power of the second external electronic apparatus 300 is turned off while being connected to the display apparatus 100. In this case, the content image 510 may include an image of the content stored in the display apparatus 100. In the UI 520, a display apparatus object 521_1 of a source apparatus menu 521 may be displayed to indicate a status to play content, and a second external electronic apparatus object 521_5 may be displayed to indicate a status in which power is turned off.

Referring to FIG. 5B, the display apparatus 100 may receive a user input to select the second external electronic apparatus 300 and may select the second external electronic apparatus 300 via the UI 520. The display apparatus 100 may verify that power of the second external electronic apparatus 300 is turned off and may turn on (e.g., control to turn on) the power of the second external electronic apparatus 300. As such, in the UI 520, a second external electronic apparatus object 521_5 of a source apparatus menu 521 may be displayed after being changed to indicate a status in which power is turned on.

Referring to FIG. 5C, the display apparatus 100 may connect the second external electronic apparatus 300 via a wired interface and may play content of the second external electronic apparatus 300. In this case, the content image 510 may include an image of content from the second external electronic apparatus 300. In the UI 520, the second external electronic apparatus object 521_5 of the source apparatus menu 521 may be displayed after being changed to a status to play content.

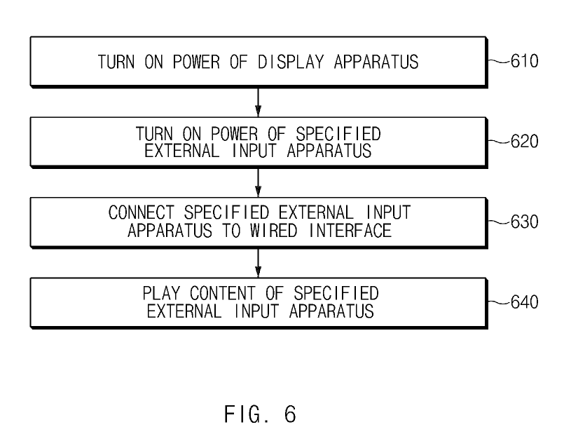

FIG. 6 is a flowchart illustrating a case where power of a display apparatus 100 according to an exemplary embodiment is turned on.

Referring to FIG. 6, the display apparatus 100 may play content received from a specified external electronic apparatus (e.g., a source apparatus) when power is turned on. The specified external electronic apparatus may be an external electronic apparatus that is the last one connected to the display apparatus 100 (or a wired interface), an external electronic apparatus that is the most connected to the display apparatus 100 in number, or an external electronic apparatus of which power is being turned on.

In operation 610, power of the display apparatus 100 may be turned on.

In operation 620, the display apparatus 100 may turn on (e.g., control to turn on) power of a specified external electronic apparatus. For example, in the case where the power of the selected external electronic apparatus is turned off, the display apparatus 100 may turn on the power of the specified external electronic apparatus.

In operation 630, the display apparatus 100 may connect the turned-on external electronic apparatus via a wired interface.

In operation 640, the display apparatus 100 may play content of the external electronic apparatus connected to the wired interface. For example, the display apparatus 100 may set the external electronic apparatus, which is connected to the wired interface, as a source apparatus, an image of which is displayed on the display and an audio signal of which is output through a speaker.

According to an exemplary embodiment, if the power of the specified external electronic apparatus is turned on when the power of the display apparatus 100 is turned on, the display apparatus 100 may play content of the specified external electronic apparatus.

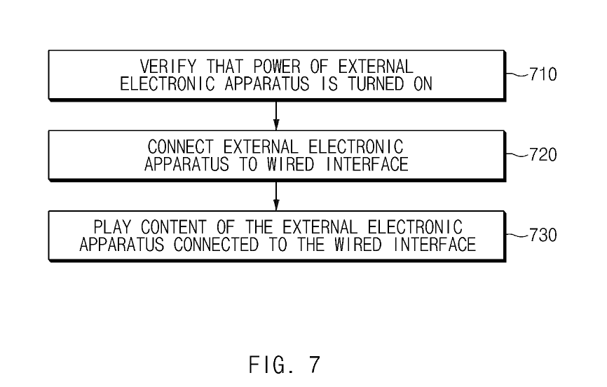

FIG. 7 is a flowchart illustrating an operation of a display apparatus 100 according to an exemplary embodiment when power of an external electronic apparatus is turned on.

Referring to FIG. 7, if power of an external electronic apparatus is turned on, the display apparatus 100 may play content of the turned-on external electronic apparatus (e.g., a source apparatus).

In operation 710, the display apparatus 100 may verify that the power of the external electronic apparatus is turned on.

In operation 720, the display apparatus 100 may connect the turned-on external electronic apparatus via a wired interface.

In operation 730, the display apparatus 100 may play content of the external electronic apparatus connected to the wired interface. For example, the display apparatus 100 may set the external electronic apparatus, which is connected to the wired interface, as a source apparatus, an image of which is displayed on the display and an audio signal of which is output through a speaker.

According to an exemplary embodiment, if power of an external electronic apparatus is turned on when the power of the display apparatus 100 is turned off, the display apparatus 100 may turn on (e.g., control to turn on) power of the display apparatus 100.

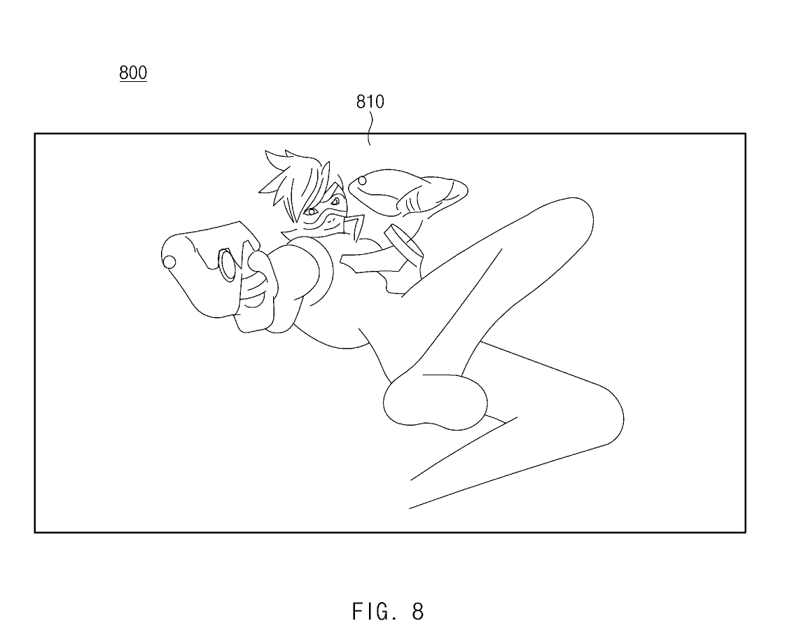

FIG. 8 is a view illustrating an image displayed on a display after an external electronic apparatus is connected to a display apparatus 100 according to an exemplary embodiment.

Referring to FIG. 8, a screen 800 displayed on a display of the display apparatus 100 may include a content image 810.

In the exemplary embodiments of FIGS. 7 and 8, the second external electronic apparatus 300 may be turned on and may be connected to the display apparatus 100. The display apparatus 100 may play content of the second external electronic apparatus 300. The content image 810 may include, for example, an image of content of the second external electronic apparatus 300.

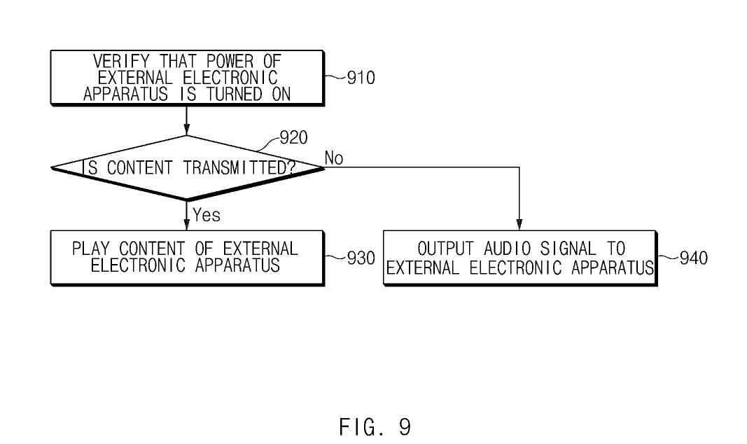

FIG. 9 is a flowchart illustrating an operation of a display apparatus 100 according to an exemplary embodiment, when power of an external electronic apparatus is turned on.

Referring to FIG. 9, the display apparatus 100 may verify whether an external electronic apparatus connected to a wired interface transmits content.

In operation 910, the display apparatus 100 may verify that power of the external electronic apparatus connected to the wired interface is turned on.

In operation 920, the display apparatus 100 may verify that the turned-on external electronic apparatus transmits content. For example, the display apparatus 100 may verify whether the turned-on external electronic apparatus transmits an image and an audio signal of content.

In operation 930, if the turned-on external electronic apparatus transmits the content, the display apparatus 100 may determine the turned-on external electronic apparatus as a source apparatus and may play the content of the turned-on external electronic apparatus. For example, the display apparatus 100 may set the turned-on external electronic apparatus to a source apparatus, an image of which is displayed on the display and an audio signal of which is output through a speaker.

In operation 940, if the turned-on external electronic apparatus does not transmit the content, the display apparatus 100 may determine the turned-on external electronic apparatus as an output apparatus and may transmit an audio signal to the turned-on external electronic apparatus so as to be output to the outside.

As such, in the case where an external electronic apparatus connected to a wired interface does not transmit content when the external electronic apparatus is turned on, the display apparatus 100 may prevent the external electronic apparatus from being changed to the source apparatus, which will play content, by determining the external electronic apparatus as an output device.

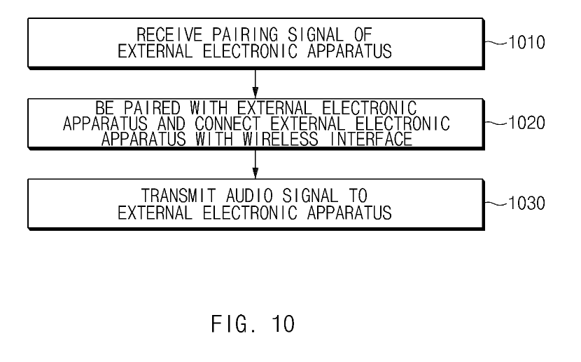

FIG. 10 is a flowchart illustrating the case where a display apparatus 100 according to an exemplary embodiment is paired with an external electronic apparatus.

Referring to FIG. 10, the display apparatus 100 may be paired and connected to an external electronic apparatus (e.g., an output apparatus).

In operation 1010, the display apparatus 100 may receive a pairing signal from the external electronic apparatus. For example, the display apparatus 100 may receive the pairing signal for connection with the external electronic apparatus from the external electronic apparatus.

In operation 1020, the display apparatus 100 may be paired with the external electronic apparatus and may connect to the external electronic apparatus via a wireless interface. For example, the display apparatus 100 may exchange information for connection with the external electronic apparatus through the wireless interface and may connect to the external electronic apparatus via the wireless interface by using the information.

In operation 1030, the display apparatus 100 may transmit an audio signal of content being played to the external electronic apparatus so as to be output to the outside. For example, the display apparatus 100 may set the external electronic apparatus as an apparatus to output the audio signal of the content.

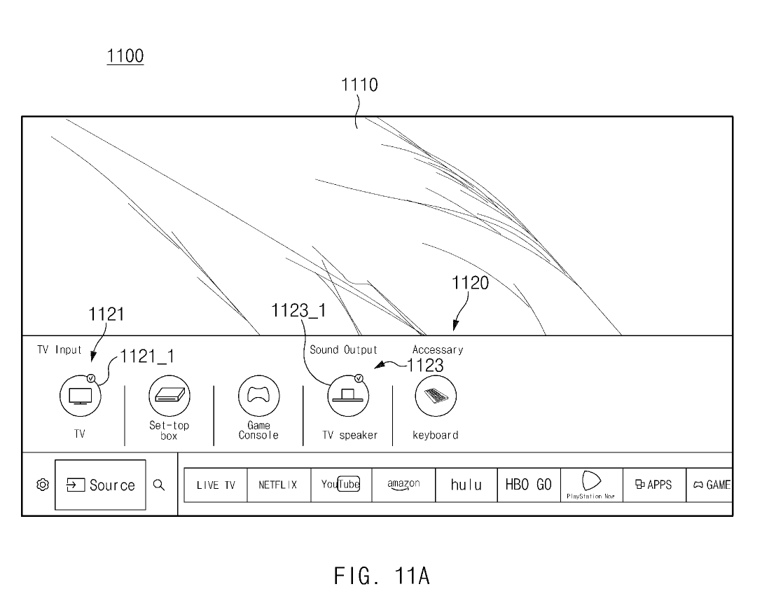

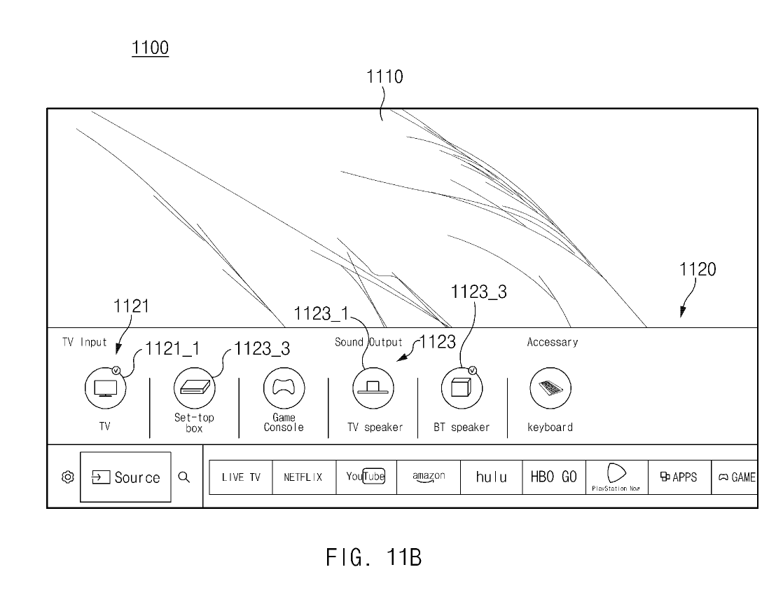

FIGS. 11A and 11B are views illustrating a UI displayed on a display in a case where an external electronic apparatus is paired with a display apparatus 100 according to an exemplary embodiment.

Referring to FIGS. 11A and 11B, a screen 1110 displayed on a display of the display apparatus 100 may include a content image 1110 and a UI 1120.

Referring to FIG. 11A, the display apparatus 100 may play content stored in the display apparatus 100. For example, the display apparatus 100 may display an image of the content on the display and may output an audio signal of the content through a speaker. As such, the content image 1110 may include an image of the content stored in the display apparatus 100. In the UI 1120, a display apparatus object 1121_1 of a source apparatus menu 1121 may be displayed to indicate a status to play content, and a display apparatus object 1123_1 of an output apparatus menu 1123 may be displayed to indicate a status to output an audio signal of content.

Referring to FIG. 11B, the display apparatus 100 may receive a pairing signal from the third external electronic apparatus 400, may be paired with the third external electronic apparatus 400, and may connect to the third external electronic apparatus 400 via a wireless interface to output the audio signal of the content. As such, in the UI 1120, a third external electronic apparatus object 1123_3 may be created in the output apparatus menu 1123, and the third external electronic apparatus object 1123_3 may be displayed to indicate a status to output the audio signal of the content.

As such, if an external electronic apparatus is paired, the display apparatus 100 may allow the paired external electronic apparatus to be connected to a wireless interface, thereby making it possible to omit an operation of asking a user's intention for connection with the wireless interface after pairing.

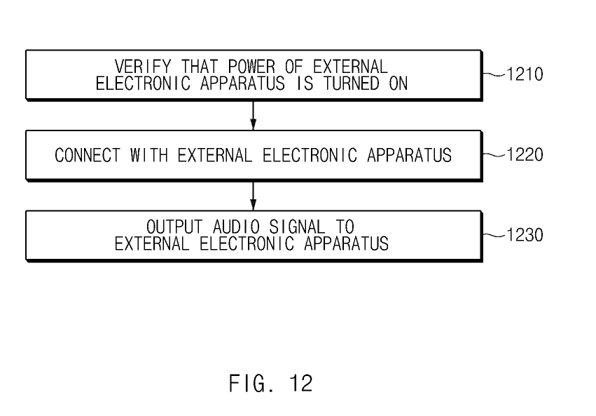

FIG. 12 is a flowchart illustrating the case where a display apparatus according to an exemplary embodiment is connected to a paired external electronic apparatus.

Referring to FIG. 12, the display apparatus 100 may be connected to an external electronic apparatus (e.g., an output apparatus) that is in a pairing state.

In operation 1210, the display apparatus 100 may verify that power of the external electronic apparatus is turned on.

In operation 1220, the display apparatus 100 may connect the external electronic apparatus to a wireless interface if the external electronic apparatus is paired with the wireless interface.

In operation 1230, the display apparatus 100 may transmit an audio signal of content being played to the external electronic apparatus so as to be output to the outside. For example, the display apparatus 100 may set the external electronic apparatus as an apparatus to output the audio signal of the content.

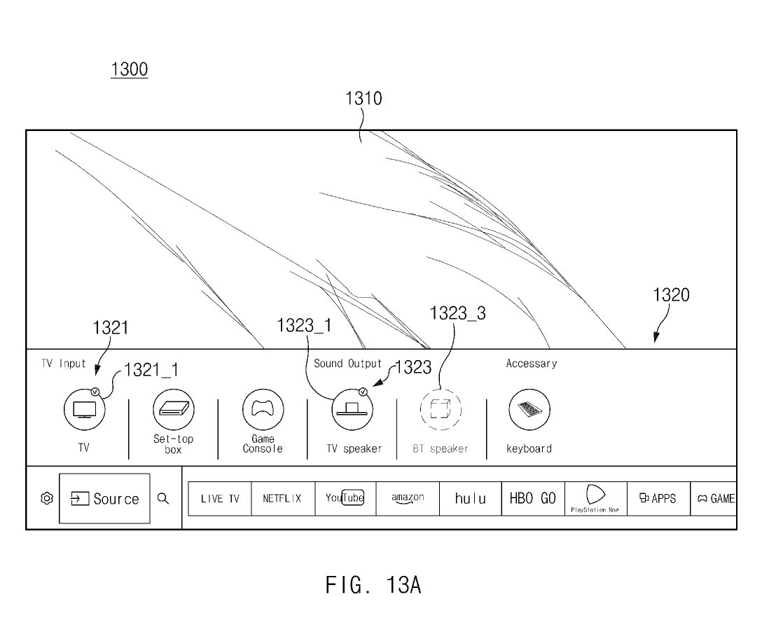

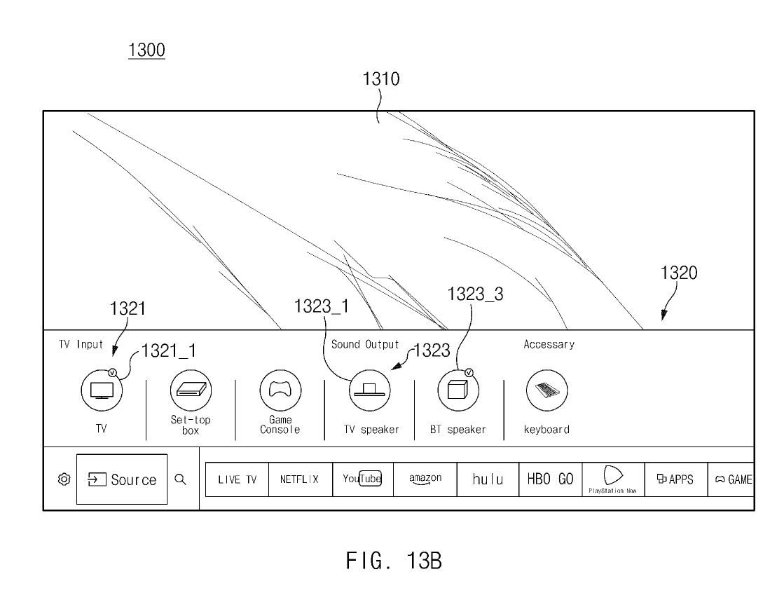

FIGS. 13A and 13B are views illustrating a UI displayed on a display in a case where a paired external electronic apparatus is connected to a display apparatus 100 according to an exemplary embodiment.

Referring to FIGS. 13A and 13B, a screen 1300 displayed on a display of the display apparatus 100 may include a content image 1310 and a UI 1320.

Referring to FIG. 13A, the display apparatus 100 may play content stored in the display apparatus 100. For example, the display apparatus 100 may display an image of the content on the display and may output an audio signal of the content through a speaker. As such, the content image 1310 may include an image of the content stored in the display apparatus 100. In the UI 1320, a display apparatus object 1321_1 of a source apparatus menu 1321 may be displayed to indicate a status to play content. A display apparatus object 1323_1 of an output apparatus menu 1323 may be displayed to indicate a status to output an audio signal of the content, and a third external electronic apparatus object 1323_3 may be displayed to indicate a status in which pairing with a wireless interface is made but no connection is made.

Referring to FIG. 13B, the display apparatus 100 may verify that the third external electronic apparatus 400 is turned on and may connect the third external electronic apparatus 400 with the wireless interface so as to output the audio signal of the content. As such, in the UI 1320, the third external electronic apparatus object 1323_3 of the output apparatus menu 1323 may be displayed after being changed to indicate a status to output the audio signal of the content.

According to various exemplary embodiments described with reference to FIGS. 1 to 4, 5A to 5C, 6 to 10, 11A, 11B, 12, 13A, and 13B, the display apparatus 100 may verify connection statuses and power statuses of a plurality of external electronic apparatuses connected to the display apparatus 100 and may present a power status of an external electronic apparatus, the connection of which is verified, in a UI. In this case, if an external electronic apparatus corresponding to a user input is selected in the UI, the display apparatus 100 may control power of the selected external electronic apparatus to play content of the selected external electronic apparatus, thereby making it possible for a user to integrally manage the plurality of external electronic apparatuses in the UI.

Also, in the case where power of the display apparatus 100 is turned on or power of an external electronic apparatus is turned on, the display apparatus 100 may control the power and connection of the external electronic apparatus to play content without a separate user input.

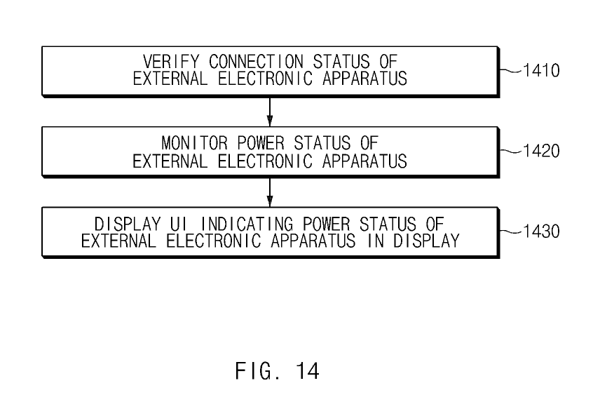

FIG. 14 is a flowchart illustrating a controlling method of a display apparatus 100 according to an exemplary embodiment.

The flowchart illustrated in FIG. 14 may include operations performed in the above-described display apparatus 100 and may indicate a controlling method of the display apparatus 100 for displaying a connection status and a power status of an external electronic apparatus connected to the display apparatus 100 in a UI. It is understood that the descriptions of the display apparatus 100 given with reference to FIGS. 1 to 4, 5A to 5C, 6 to 10, 11A, 11B, 12, 13A, and 13B may be applied to the flowchart illustrated in FIG. 14.

In operation 1410, the display apparatus 100 may verify connection statuses of a plurality of external electronic apparatuses connected to the display apparatus 100. For example, the display apparatus 100 may verify connection statuses of a plurality of external electronic apparatuses connected to a wired interface.

In operation 1420, the display apparatus 100 may monitor power statuses of a plurality of external electronic apparatuses, the connection of which is verified. For example, the display apparatus 100 may periodically verify power statuses of the plurality of external electronic apparatuses, the connection of which is verified.

In operation 1430, the display apparatus 100 may present the power statuses of the plurality of external electronic apparatuses, the connection of which is verified, in a UI. For example, the display apparatus 100 may not display a status of an external electronic apparatus, the connection of which is not verified (e.g., which is disconnected), in the UI.

At least a part of an apparatus (e.g., modules or functions thereof) or a method (e.g., operations) according to one or more exemplary embodiments may be implemented by instructions stored in a computer-readable storage medium in the form of a program module. The instruction, when executed by a processor, may cause the processor to perform a function corresponding to the instruction. The computer-readable recording medium may include a hard disk, a floppy disk, a magnetic media (e.g., a magnetic tape), an optical medium (e.g., a compact disc read only memory (CD-ROM), a digital versatile disc (DVD), or a magneto-optical media (e.g., a floptical disk)), an embedded memory, or the like. The instruction may include a code created by a complier or a code executable by an interpreter.

Operations executed by modules, program modules, or other elements may be executed by a successive method, a parallel method, a repeated method, or a heuristic method. Alternatively, at least some of the operations may be executed in another order or may be omitted, or any other operation may be added. While exemplary embodiments have been shown and described above, it will be understood by those skilled in the art that various changes in form and details may be made therein without departing from the spirit and scope of the present disclosure as defined by the appended claims and their equivalents.

What is claimed is:

1. A display apparatus comprising:
a wired interface;
a display; and
a processor configured to:
determine a connection status of an external electronic apparatus with respect to the wired interface,
determine a power status of the external electronic apparatus determined to be connected to the wired interface, and
control to present, in a user interface (UI) on the display, the determined power status of the external electronic apparatus.

2. The display apparatus of claim 1, wherein the processor is configured to:
verify at least one of a voltage pulled when the external electronic apparatus is connected, extended display identification data (EDID) of the external electronic apparatus, and a content signal to verify the connection status of the external electronic apparatus.

3. The display apparatus of claim 1, wherein the processor is configured to:
receive a user input with respect to the UI from a user;
select the external electronic apparatus corresponding to the user input; and
connect to the selected external electronic apparatus via the wired interface.

4. The display apparatus of claim 3, wherein the processor is configured to:
if power of the selected external electronic apparatus is turned off, control to turn on the power of the selected external electronic apparatus and to connect the turned-on external electronic apparatus via the wired interface.

5. The display apparatus of claim 3, wherein the processor is configured to:
set the selected external electronic apparatus, which is connected via the wired interface, as a source apparatus, an image from which is displayed on the display.

6. The display apparatus of claim 1, wherein the processor is configured to:
if power of a specified external electronic apparatus is turned on while power of the display apparatus is turned on, set the specified external electronic apparatus as a source apparatus, an image from which is displayed on the display; and
if the power of the specified external electronic apparatus is turned off while the power of the display apparatus is turned on, control to turn on the power of the specified external electronic device and set the specified external electronic apparatus as the source apparatus, the image from which is displayed on the display.

7. The display apparatus of claim 6, wherein the specified external electronic apparatus is an external electronic apparatus that is last connected via the wired interface, an external electronic apparatus that is most connected to the wired interface, or an external electronic apparatus, power of which is being turned on.

8. The display apparatus of claim 1, wherein the processor is configured to:
if power of the external electronic apparatus is turned on, control to connect the external electronic apparatus via the wired interface and set the external electronic apparatus as a source apparatus, an image of which is displayed on the display.

9. The display apparatus of claim 8, wherein the processor is configured to:
if the power of the external electronic apparatus is turned on when power of the display apparatus is turned off, control to turn on the power of the display apparatus.

10. The display apparatus of claim 1, wherein the processor is configured to:
if power of the external electronic apparatus is turned on, determine whether the external electronic apparatus transmits an image; and
based on determining that the external electronic apparatus does not transmit the image, control to not change a source apparatus, an image of which is displayed on the display, to the external electronic apparatus.

11. The display apparatus of claim 1, further comprising:
a wireless interface,
wherein the processor is configured to:
determine a connection status of an external electronic apparatus connected to the wireless interface, and
control to present the determined connection status of the external electronic apparatus connected to the wireless interface in the UI.

12. The display apparatus of claim 11, wherein the processor is configured to:
based on the external electronic apparatus being paired with the wireless interface or the display apparatus, control to connect to the external electronic apparatus via the wireless interface.

13. The display apparatus of claim 11, wherein the processor is configured to:
if the external electronic apparatus is paired with the wireless interface while power of the external electronic apparatus connected to the wireless interface is turned on, control to connect to the external electronic apparatus via the wireless interface.

14. The display apparatus of claim 12, wherein the processor is configured to:
set the external electronic apparatus connected to the wireless interface as an output apparatus to output an audio signal from the display apparatus.

15. A controlling method of a display apparatus, the method comprising:
determining a connection status of an external electronic apparatus with respect to a wired interface;
determining a power status of the external electronic apparatus determined to be connected to the wired interface; and
presenting a user interface (UI) indicating the determined power status of the external electronic apparatus.

16. The method of claim 15, wherein the determining the connection status of the external electronic apparatus comprises:
verifying at least one of a voltage pulled when the external electronic apparatus is connected, extended display identification data (EDID) of the external electronic apparatus, and a content signal to verify the connection status of the external electronic apparatus.

17. The method of claim 15, further comprising:
receiving a user input with respect to the UI from a user;
selecting the external electronic apparatus corresponding to the user input; and
connecting to the selected external electronic apparatus via the wired interface.

18. The method of claim 17, wherein the connecting to the selected external electronic apparatus comprises:
controlling to turn on power of the selected external electronic apparatus if the power of the selected external electronic apparatus is turned off; and
connecting to the turned-on external electronic apparatus via the wired interface.

19. The method of claim 17, further comprising:
setting the selected external electronic apparatus connected via the wired interface as a source apparatus, an image from which is displayed on the display.

20. A non-transitory computer-readable storage medium storing a program executable by a computer for performing a method, the method comprising:
determining a connection status of an external electronic apparatus with respect to a wired interface;
determining a power status of the external electronic apparatus; and
presenting, on a display, a user interface (UI) indicating the determined power status of the external electronic apparatus.
